(19) United States
(12) Patent Application Publication
(10) Pub. No.: US 2025/0033233 A1
(43) Pub. Date: Jan. 30, 2025

(54) CURVED BLADE DERMAPLANING DEVICE

(71) Applicant: Church & Dwight Co., Inc., Princeton, NJ (US)

(72) Inventors: Gerhart P. Huy, Hamilton Square, NJ (US); Nicholas Garibaldi, Princeton, NJ (US)

(73) Assignee: Church & Dwight Co., Inc., Princeton, NJ (US)

(21) Appl. No.: 18/784,473

(22) Filed: Jul. 25, 2024

Related U.S. Application Data
(60) Provisional application No. 63/516,345, filed on Jul. 28, 2023.

(51) Int. Cl. B26B 21/56; B26B 21/16; B26B 29/02

(52) U.S. Cl. CPC B26B 21/56; B26B 21/16; B26B 29/02

(57) ABSTRACT

A curved blade dermaplaning device is disclosed. The device includes a handle having a first portion and a second portion defining a gripping region and a curved blade assembly engageable with or coupled to the first portion of the handle. The curved blade assembly includes a blade having a length defined between a first end and a second end thereof and forming an arcuate shape along its length, the blade including a cutting edge formed at an intersection between lateral sides of the blade, and a first blade guard having a length defined between a first end and a second end thereof and forming the arcuate shape along its length, wherein the first blade guard is arranged to at least partially cover the cutting edge of the blade.

### CROSS-REFERENCE TO RELATED APPLICATIONS

This application claims priority from U.S. Application No. 63/516,345, filed on Jul. 28, 2023, which application is hereby incorporated in its entirety by reference in this application.

### FIELD OF THE DISCLOSURE

The invention relates to a dermaplaning device, and more particularly a curved blade dermaplaning device. More particularly, this invention allows users to safely and effectively scrape curved areas on the epidermis to create a variety of cosmetic benefits for the skin. Dermaplaning helps to smooth skin, exfoliate the skin, reduce the appearance of wrinkles and scars, promotes the productions of collagen and elastin, and to clean the skin.

### BACKGROUND

Various processes are known for treating facial skin. These processes are known to include hand-held devices and fall into several categories as follows: shaving, cleansing and moisturizing, dermabrasion, dermaplaning (exfoliation), and debridement. Of these categories, dermaplaning is a relatively popular process that is relatively simple and safe and is used for exfoliating the epidermis, i.e., an outer layer of cells in the skin, and removing fine vellus hair, i.e., “peach fuzz,” from the skin. Dermaplaning is a process normally performed by licensed skin care professionals, such as estheticians, because of the use of a surgical scalpel or similar blade to exfoliate the epidermis. Using a straight edge scalpel and a delicate touch, the scalpel is swept across the skin with light feathering strokes to exfoliate the skin to remove the oldest dead skin cells on the skin's outermost surface. Such scalpels are not available for non-professional use. As such, dermaplaning is only available at spas with licensed skin care professionals. Such dermaplaning treatments at spas can be relatively expensive.

Dermaplaning facial skin has many benefits. For example, removing epidermal skin allows skin care products to penetrate more readily into deeper layers of the skin for better results. As mentioned above, dermaplaning removes vellus hair which tends to cause a build-up of dirt and oils in the follicles. Removal of the hair results in healthier looking skin. Unfortunately, all known dermaplaning devices rely on a straight blade to remove the vellus hair, which work best on flat regions of the epidermis. However, most of the face (as well as other surfaces on the body) is curved and contoured such that the user must awkwardly manipulate the straight blade of the dermaplaning device in order to remove the vellus hair from these curved regions.

Accordingly, there exists a need for a curved blade dermaplaning device that addresses or solves at least the issues mentioned herein.

### BRIEF SUMMARY OF THE DISCLOSURE

The present disclosure relates to a curved blade dermaplaning device and related method which advantageously reduces the problems associated with conventional dermaplaning devices and systems.

The present disclosure thus includes, without limitation, the following embodiments:

In one example embodiment, a dermaplaning device comprising: a handle having a first portion and a second portion defining a gripping region; and a curved blade assembly engageable with or coupled to the first portion of the handle and comprising: a blade having a length defined between a first end and a second end thereof and forming an arcuate shape along its length, the blade comprising a cutting edge formed at an intersection between lateral sides of the blade, and a first blade guard having a length defined between a first end and a second end thereof and forming the arcuate shape along its length, wherein the first blade guard is arranged to at least partially cover the cutting edge of the blade, is provided.

In some example embodiments of the device of any preceding example embodiment, or any combination of any preceding example embodiments, the first blade guard comprises: a planar body portion extending between the first end and the second end of the first blade guard and forming the arcuate shape along its length, and guard teeth extending from and coplanar with the planar body portion in a planar configuration and orientable transversely to the planar body portion of the first blade guard in a non-coplanar configuration, wherein the planar body portion of the first blade guard is arranged adjacent to one of the lateral sides of the blade and the guard teeth of the first blade guard are folded over the cutting edge of the blade in the non-coplanar configuration to partially cover the cutting edge of the blade.

In some example embodiments of the device of any preceding example embodiment, or any combination of any preceding example embodiments, the curved blade assembly further comprises a second blade guard having a length defined between a first end and a second end thereof and forming the arcuate shape along its length, the second blade guard comprising: a planar body portion extending between a first end and the second end of the second blade guard and forming the arcuate shape along its length, and guard teeth extending from and coplanar with the planar body portion in a planar configuration and orientable transversely to the planar body portion of the second blade guard in a non-coplanar configuration, wherein the planar body portion of the second blade guard is arranged adjacent to the other one of the lateral sides of the blade and the guard teeth of the second blade guard are folded over the cutting edge of the blade in the non-coplanar configuration to further partially cover the cutting edge of the blade.

In some example embodiments of the device of any preceding example embodiment, or any combination of any preceding example embodiments, the guard teeth of the first blade guard and the guard teeth of the second blade guard oppose one another and are alternately folded over the cutting edge of the blade in the non-coplanar configurations thereof.

In some example embodiments of the device of any preceding example embodiment, or any combination of any preceding example embodiments, the curved blade assembly comprises a blade housing having a portion forming the arcuate shape and to which the blade and the first blade guard are engaged with, the blade housing of the curved blade assembly being engageable with or coupled to the first portion of the handle.

In some example embodiments of the device of any preceding example embodiment, or any combination of any preceding example embodiments, the first portion of the handle and the blade housing are integrally formed as a single unit, or the blade housing is attachable to and removable from the first portion of the handle.

In some example embodiments of the device of any preceding example embodiment, or any combination of any preceding example embodiments, the blade housing defines a recess for engaging the blade and the first blade guard.

In some example embodiments of the device of any preceding example embodiment, or any combination of any preceding example embodiments, the device further comprises a cover arrangeable about the curved blade assembly so as to at least partially enclose the curved blade assembly.

In some example embodiments of the device of any preceding example embodiment, or any combination of any preceding example embodiments, the curved blade assembly is longitudinally offset from the second portion of the handle.

In some example embodiments of the device of any preceding example embodiment, or any combination of any preceding example embodiments, the arcuate shape defines a degree of curvature of between about 36 degrees and 37 degrees.

In another example embodiment, a method for manufacturing a curved blade dermaplaning device comprising forming a curved blade assembly, the curved blade assembly comprising a blade having a length defined between a first end and a second end thereof and forming an arcuate shape along its length, the blade comprising a cutting edge formed at an intersection between lateral sides of the blade, and a first blade guard having a length defined between a first end and a second end thereof and forming the arcuate shape along its length, wherein the first blade guard is arranged to at least partially cover the cutting edge of the blade; and engaging or coupling a first portion of a handle with the curved blade assembly, the handle having the first portion and a second portion defining a gripping region, is provided.

In some example embodiments of the method of any preceding example embodiment, or any combination of any preceding example embodiments, the first blade guard comprises a planar body portion extending between the first end and the second end of the first blade guard and forming the arcuate shape along its length, and guard teeth extending from and coplanar with the planar body portion in a planar configuration and orientable transversely to the planar body portion of the first blade guard in a non-coplanar configuration, and wherein forming the curved blade assembly comprises: arranging the planar body portion of the first blade guard adjacent to one of the lateral sides of the blade; and folding the guard teeth of the first blade guard over the cutting edge of the blade in the non-coplanar configuration to partially cover the cutting edge of the blade.

In some example embodiments of the method of any preceding example embodiment, or any combination of any preceding example embodiments, the curved blade assembly further comprises a second blade guard having a length defined between a first end and a second end thereof and forming the arcuate shape along its length, the second blade guard comprising a planar body portion extending between a first end and the second end of the second blade guard and forming the arcuate shape along its length, and guard teeth extending from and coplanar with the planar body portion in a planar configuration and orientable transversely to the planar body portion of the second blade guard in a non-coplanar configuration, and wherein forming the curved blade assembly comprises: arranging the planar body portion of the second blade guard adjacent to the other one of the lateral sides of the blade; and folding the guard teeth of the second blade guard over the cutting edge of the blade in the non-coplanar configuration to further partially cover the cutting edge of the blade.

In some example embodiments of the method of any preceding example embodiment, or any combination of any preceding example embodiments, the guard teeth of the first blade guard and the guard teeth of the second blade guard oppose one another, and wherein forming the curved blade assembly comprises alternately folding the opposing guard teeth of the first blade guard and the guard teeth of the second blade guard over the cutting edge of the blade in the non-coplanar configurations thereof.

In some example embodiments of the method of any preceding example embodiment, or any combination of any preceding example embodiments, the curved blade assembly further comprises a blade housing having a portion forming the arcuate shape; and wherein forming the curved blade assembly comprises engaging the blade housing with the blade and the first blade guard, and wherein engaging or coupling the first portion of the handle with the curved blade assembly comprises engaging or coupling the blade housing of the curved blade assembly to the first portion of the handle.

In some example embodiments of the method of any preceding example embodiment, or any combination of any preceding example embodiments, engaging or coupling the first portion of the handle with the curved blade assembly comprises: integrally forming the first portion of the handle and the blade housing as a single unit; or attachably and removably engaging or coupling the blade housing with the first portion of the handle.

In some example embodiments of the method of any preceding example embodiment, or any combination of any preceding example embodiments, forming the curved blade assembly comprises forming a recess in the blade housing for engaging the blade and the first blade guard.

In some example embodiments of the method of any preceding example embodiment, or any combination of any preceding example embodiments, the method further comprises arranging a cover about the curved blade assembly so as to at least partially enclose the curved blade assembly.

In some example embodiments of the method of any preceding example embodiment, or any combination of any preceding example embodiments, engaging or coupling the first portion of the handle with the curved blade assembly comprises engaging or coupling the first portion of the handle with the curved blade assembly so that the curved blade assembly is longitudinally offset from the second portion of the handle.

In some example embodiments of the method of any preceding example embodiment, or any combination of any preceding example embodiments, forming the curved blade assembly comprises forming the arcuate shape of the blade and the first blade guard, the arcuate shape defining a degree of curvature of between about 36 degrees and 37 degrees.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure or recited in any one or more of the claims, regardless of whether such features or elements are expressly combined or otherwise recited in a specific embodiment description or claim herein. This disclosure is intended to be read holistically such that any separable features or elements of the disclosure, in any of its aspects and embodiments, should be viewed as intended to be combinable, unless the context of the disclosure clearly dictates otherwise.

### BRIEF DESCRIPTION OF THE DRAWINGS

Having thus described the disclosure in general terms, reference will now be made to the accompanying drawings, which are not necessarily drawn to scale, and wherein:

FIG. 1 is a side view of a curved blade dermaplaning device according to an example embodiment of the present disclosure;

FIG. 2A is a perspective view of a handle of a curved blade dermaplaning device according to an example embodiment of the present disclosure;

FIG. 2B is a perspective view of a curved blade assembly of a curved blade dermaplaning device according to an example embodiment of the present disclosure;

FIG. 3 is a perspective side view of the curved blade dermaplaning device of FIG. 1;

FIG. 4A is top perspective view of a planar configuration of a first and a second blade guard of a curved blade assembly of a curved blade dermaplaning device according to an example embodiment of the present disclosure;

FIG. 4B is a perspective side view of a non-coplanar configuration of a first and second blade guard folded over a curved blade of a curved blade assembly of a curved blade dermaplaning device according to an example embodiment of the present disclosure;

FIG. 4C is an exploded view of a non-planar configuration of a curved blade assembly of a curved blade dermaplaning device according to an example embodiment of the present disclosure;

FIGS. 4D-4E are opposing side views of a non-planar configuration of a curved blade assembly of a curved blade dermaplaning device according to an example embodiment of the present disclosure;

FIG. 5 is a side view of the curved blade dermaplaning device of FIG. 1 with a cover; and

FIG. 6 is a method flow diagram of a method for manufacturing a curved blade dermaplaning device according to an example embodiment of the present disclosure.

### DETAILED DESCRIPTION OF PREFERRED EMBODIMENTS

The present disclosure will now be described more fully hereinafter with reference to exemplary embodiments thereof. These exemplary embodiments are described so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural variations unless the context clearly dictates otherwise.

A curved blade dermaplaning device as disclosed herein may be used to “dermaplane” or scrape an exterior surface of an object to remove any debris, fibers, hairs, etc., in order to leave the exterior surface smooth. In some example embodiments, the object is a mammalian user and the exterior surface is the exposed skin and, more particularly, the epidermis of the mammalian user, such that the curved dermaplaning device may be used to scrape or skim the epidermis of the user to create a variety of cosmetic benefits for the skin. For example, using the curved dermaplaning device disclosed herein on the epidermis of a mammalian user advantageously smooths at least the epidermis layer of the skin, exfoliates the epidermis, reduces the appearance of wrinkles and scars in the skin, promotes the production of collagen and elastin in the skin, and cleans the epidermis, among other benefits.

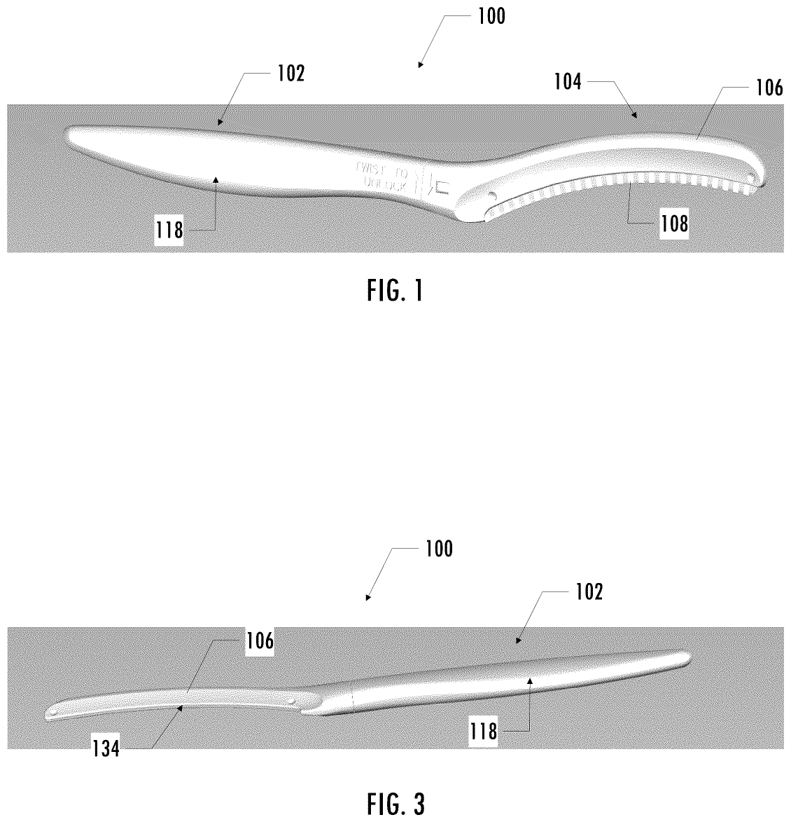

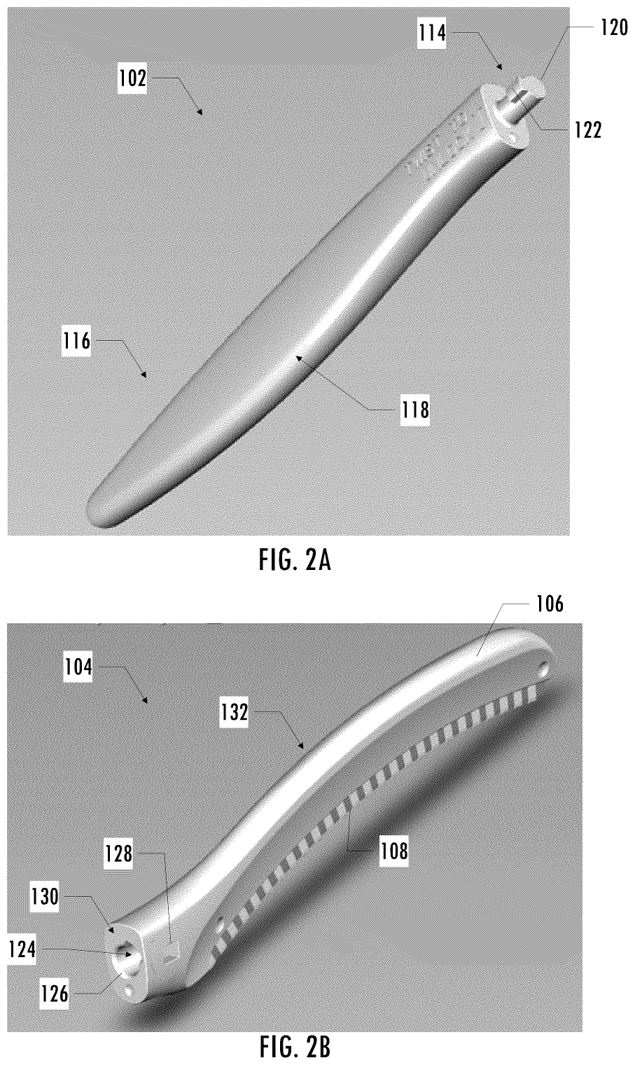

Turning now to FIG. 1, a first example embodiment of a curved blade dermaplaning device 100 is disclosed. FIG. 1 illustrates a curved blade dermaplaning device 100 comprising a handle 102 and a curved blade assembly 104 including a blade housing 106, a blade 108, and a first and a second blade guard 110, 112 in a non-coplanar configuration. The handle 102 has a first portion 114 (see FIG. 2A) and a second portion 116 defining a gripping region 118. The curved blade assembly 104 may be engageable with or coupled to the first portion 114 of the handle 102. In some example embodiments, the curved blade assembly 104 and the handle 102 are integrally formed as a single unit with one another, such that the curved blade assembly 104 and the handle 102 are formed as one. In this example embodiment, the first portion 114 of the handle 102 and the blade housing 106 are fixedly engaged with or coupled to one another or otherwise formed such that they may be considered the same component with a seamless transition between the two. In other example embodiments, the curved blade assembly 104 and the handle 102 are separable and removable from one another so that the handle 102 is reusable with a replacement curved blade assembly 104. In this example embodiment, the first portion 114 of the handle 102 removably engages with or couples to the blade housing 106 of the curved blade assembly 104 via screw-fit engagement, press-fit engagement, magnetic engagement, and the like.

One example embodiment of an attachable/detachable handle 102 and curved blade housing 106 is shown in FIGS. 2A and 2B, respectively. As shown in FIG. 2A, for example, the first portion 114 of the handle 102 may define a protrusion 120 with a locking member 122 extending therefrom, while in FIG. 2B, the blade housing 106 of the curved blade assembly 104 may define a cavity 124 having a first and second opening 126, 128. The first opening 126 may be oriented about a central axis of the blade housing 106 and sized and shaped to receive the protrusion 120 with the locking member 122 when the curved blade assembly 104 is engaged with the handle 102. The second opening 128 may be defined on a lateral side of the blade housing 106 and in communication with the first opening 126. Upon alignment of the protrusion 120 with the locking member 122 with the first opening 126, the protrusion 120 with the locking member 122 may be inserted into the first opening 126. The handle 102 may then be twisted or rotated clockwise to rotate the protrusion 120 with the locking member 122 within the cavity 124 such that the locking member 122 is rotated into the engagement with the second opening 128 and thus securely retained in place. Pressure applied to the locking member 122 within the second opening 128 and simultaneous rotation of the handle 102 counter-clockwise may cause the locking member 122 to disengage from the second opening 128 so that the protrusion 120 and the locking member 122 may then be removed from the first opening 126, and the handle 102 thereby disengaged from the blade housing 106 of the curved blade assembly 104.

One or both of the handle 102 and the blade housing 106 may be formed as a molded plastic, or otherwise be a composite of plastic materials, metallic materials, wood, stone or other natural materials, recycled materials (either partially or completely), waste materials such as husks or shells from nuts, natural or man-made fibers, or any combination thereof. The gripping region 118 of the second portion of the handle 102 may be formed as an overmolded elastomeric component that prevents sliding of the user's hand during use of the curved blade dermaplaning device 100. The gripping region 118 may comprise a similar material or a different material than the material of the first portion 114 and/or second portion 116 of the handle 102. For example, the gripping region 118 may comprise elastomeric materials, metallic materials, or any combination thereof, and may have a textured surface or comprise additional materials having a lower durometer or higher coefficient of friction than the rest of the handle 102 so as to reduce slippage. The material of the gripping region 118 may be in the form of a continuous region, or may be in the form of a pattern of discrete grips that form the gripping region 118 when viewed in their totality.

A longitudinal axis may extend along a length of the handle 102 defined between the first portion 114 and the second portion 116. When engaged, the curved blade assembly 104 may be offset from the longitudinal axis and the second portion 116 of the handle 102, or the handle 102 and the curved blade assembly 104 may be in alignment along the longitudinal axis. As shown in FIG. 1, the curved blade assembly 104, and specifically the blade housing 106, is longitudinally offset from the second portion 116 of the handle 102. As used herein, “longitudinally offset” refers to the curved blade assembly 104 being angled (e.g., about 25 degrees) relative to the longitudinal axis of the handle 102. This advantageously allows a user to grip the gripping region 118 formed on the second portion 116 of the handle 102 without having the user's grip brush against the exterior surface of the object on which the curved blade dermaplaning device 100 is being used.

The blade housing 106 may define two portions 130, 132. A first portion 130 of the blade housing 106 may be configured for attaching to the first portion 114 of the handle 102. A second portion 132 of blade housing 106 may form an arcuate shape along its length defined between first and second ends of the second portion 132, the second end of the second portion 132 being arranged between the first end and the first portion 130 of the blade housing 106 (i.e., the second portion 132 of the blade housing 106 is curved). In some example embodiments, the arcuate shape defines a degree of curvature. The degree of curvature of the arcuate shape is based on the premise that the arcuate shape follows a curve of a corresponding circle, with a known radius. In some example embodiments, the radius may be between about two inches and about six inches, and preferably about four inches. Other radii may also be considered. Based on the known radius, the degree of curvature may be determined using standard geometric formulae. In some example embodiments, the degree of curvature using a radius of between about two inches and about six inches may be between about 30 degrees and about 40 degrees, and particularly between about 36 degrees and 37 degrees where a four inch radius is used. However, the entirety of or one or both of the first portion 130 and second portion 132 of the blade housing 106 may also be linear, or otherwise shaped. As shown in FIG. 1, for example, the second portion 132 of the blade housing 106 forms an arcuate shape defining a degree of curvature of about 36.42 degrees.

Referring now to FIG. 3, which is a perspective side view of the device in FIG. 1, the blade housing 106 is engaged with or coupled to the handle 102 without the blade 108 or first and second blade guards 110, 112. The blade housing 106 may define a recess 134 for fixedly or removably engaging the blade 108 and the first and/or second blade guard(s) 110, 112. The recess 134 may extend longitudinally relative to the blade housing 106 and be shaped and sized so as to removably or permanently engage the blade 108 and the first and/or second blade guard(s) 110, 112. The blade housing 106, the blade 108, and the first and/or second blade guard(s) 110, 112 may be integrally formed as a single unit, i.e., the blade housing 106 is molded over the blade 108 and the first and/or second blade guard(s) 110, 112, or the blade 108 and the first and/or second blade guard(s) 110, 112 are attachable to and removable from the recess 134 of the blade housing 106. Where the blade and the first and/or second blade guard(s) 110, 112 are removable relative to the blade housing 106, an engagement mechanism (not shown) may be provided about the curved blade dermaplaning device 100 (e.g., about the handle 102 or the blade housing 106) to allow for engagement and disengagement of the blade 108 and the first and/or second blade guard(s) 110, 112 from the recess 134. In this example embodiment, the blade 108 and the first and/or second blade guard(s) 110, 112 may be engageable with the blade housing 106 through one or more mechanisms, such as magnets, a press fit, a snap fit, a twist lock, a biased lock, or combinations thereof.

In some example embodiments, a release button (not shown) may be provided adjacent to the recess 134 near the blade housing 106 or the handle 102. The release button may be slideable in a parallel direction relative to the recess 134, the blade housing 106, and/or handle 102 from an initial position in which the blade 108 and the first and/or second blade guard(s) 110, 112 are securely engageable with the recess 134 to a second position that allows the blade 108 and the first and/or second blade guard(s) 110, 112 to be released from the recess 134. In some other example embodiments, the release button is slidable in a perpendicular direction relative to the recess 134, the blade housing 106, and/or handle 102. A biasing mechanism or spring may be utilized to urge the engagement mechanism into the initial position, such that sliding the engagement mechanism into the second position puts tension on the engagement mechanism so as to urge the engagement mechanism back into the initial position once sliding pressure is removed. The engagement mechanism may also be any other type of mechanism that is arranged to engage and release the blade 108 and the first and/or second blade guard(s) 110, 112.

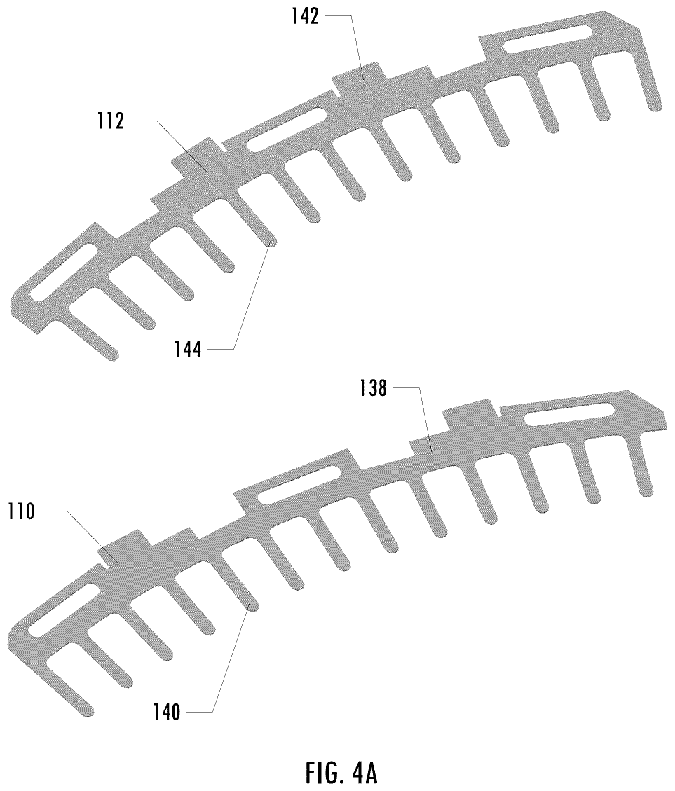

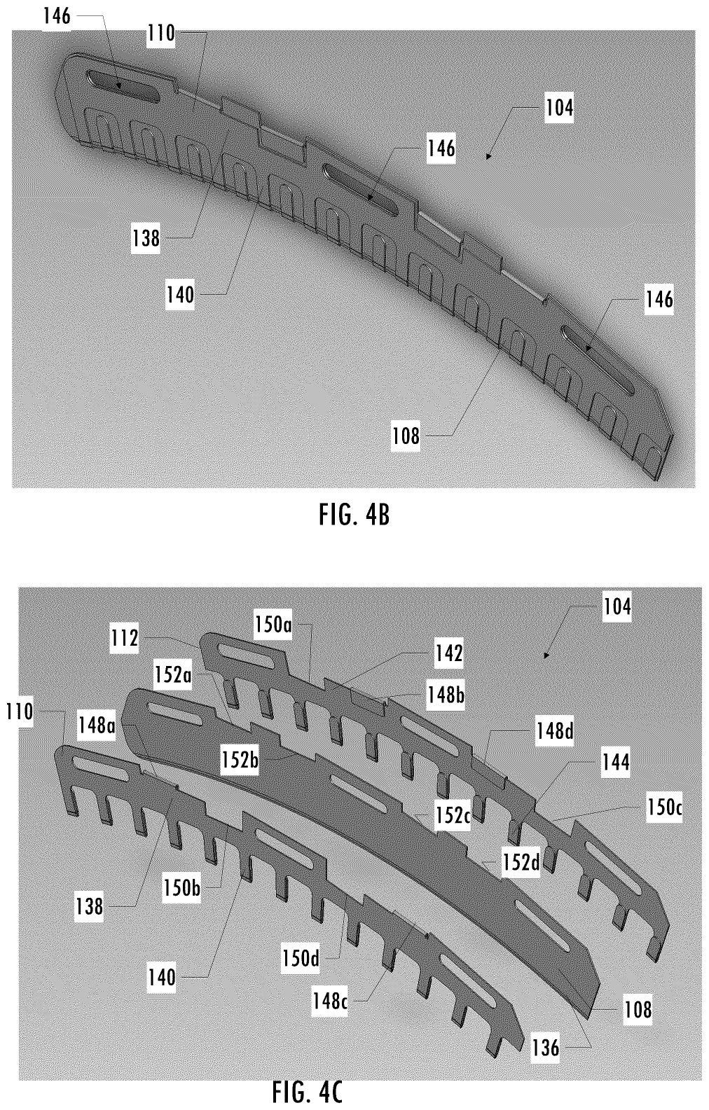

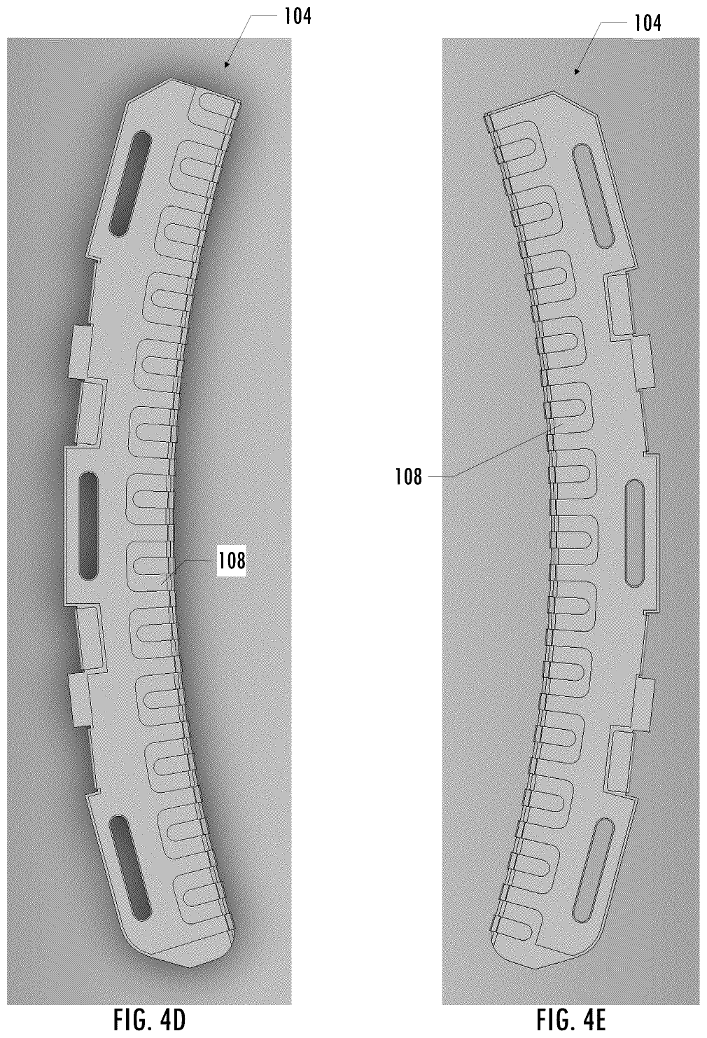

Turning now to FIGS. 4A-4E, the blade 108 and first and second blade guards 110, 112 are illustrated separate from the blade housing 106. The blade 108 and first and second blade guard(s) 110, 112 may be manufactured as a unit such that if they are removable from the blade housing 106, the blade 108 and first and second blade guards 110, 112 are removed as a unit. Otherwise, one or more components of the blade 108 and first and second blade guards 110, 112 may be separately removable and replaceable relative to the handle 102.

In some example embodiments, the blade 108 has a length defined between a first end and a second end thereof and comprises a cutting edge formed at an intersection between lateral sides of the blade 108. An edge of the blade 108 opposite the cutting edge 136 and formed at an intersection between the lateral sides of the blade 108 may be the top edge of the blade 108 that is engageable with the recess 134 of the blade housing 106. The blade 108 may be any type of blade sharpened on one edge (i.e., the cutting edge). The blade 108 may comprise stainless steel, high carbon steel, or another similar material.

The first blade guard 110 may have a length defined between a first end and a second end thereof and forming the arcuate shape along its length. The first blade guard 110 may comprise a planar body portion 138 extending between the first end and the second end of the first blade guard 110 and forming the arcuate shape along its length, and guard teeth 140 extending from and coplanar with the planar body portion 138 in a planar configuration and orientable transversely to the planar body portion 138 of the first blade guard 110 in a non-coplanar configuration. The planar configuration of the first blade guard 110 is illustrated in FIG. 4A, while the non-coplanar configuration of the first blade guard 110 is illustrated in FIGS. 4B-4E. As shown in FIG. 4B, the planar body portion 138 of the first blade guard 110 may be arranged adjacent to one of the lateral sides of the blade 108 and the guard teeth 140 of the first blade guard 140 may be folded over the cutting edge 136 of the blade 108 in the non-coplanar configuration to partially cover the cutting edge 136 of the blade 108. The first blade guard 110 may comprise stainless steel, high carbon steel, or another similar material, and may be the same as or a different material than the blade 108.

Likewise, the second blade guard 112 may have a length defined between a first end and a second end thereof and forming the arcuate shape along its length. The second blade guard 112 may comprise a planar body portion 142 extending between a first end and the second end of the second blade guard 112 and forming the arcuate shape along its length, and guard teeth 144 extending from and coplanar with the planar body portion 142 in a planar configuration and orientable transversely to the planar body portion 142 of the second blade guard 112 in a non-coplanar configuration. The planar configuration of the second blade guard 112 is illustrated in FIG. 4A, while the non-coplanar configuration of the second blade guard 112 is illustrated in FIGS. 4B-4E. As shown in FIG. 4B, the planar body portion 142 of the second blade guard 112 may be arranged adjacent to the other one of the lateral sides of the blade 108 and the guard teeth 144 of the second blade guard 110 may be folded over the cutting edge 136 of the blade 108 in the non-coplanar configuration to further partially cover the cutting edge 136 of the blade 108. The second blade guard 112 may comprise stainless steel, high carbon steel, or another similar material, and may be the same as or a different material than the blade 108.

In the non-coplanar configurations and as shown in FIGS. 4B and 4D-4E, the guard teeth 140 of the first blade guard 110 and the guard teeth 144 of the second blade guard 112 may oppose one another and may be alternately folded over the cutting edge 136 of the blade 108. As shown in FIG. 4C, for example, when folded, the guard teeth 140, 144 have a U-shaped profile. This enables the blade 108 to be sandwiched between the first blade guard 110 and the second blade guard 112 to limit the cutting depth of the blade 108 during use. The guard teeth 140, 144 on the first blade guard 110 and the second blade guard 112 may be substantially uniform in width or may be tapered. A width of the guard teeth 140, 144 may be smaller than a width between each guard tooth 140, 144, which is desirable so as to not fully cover the cutting edge 136 in the non-coplanar configuration.

Accordingly, and as shown in FIGS. 4A-4E, the blade 108, first blade guard 110, and/or second blade guard 112 (i.e., a portion of the curved blade assembly 104) may form an arcuate shape along each of their respective lengths. The arcuate shape formed by the blade 108, first blade guard 110, and/or second blade guard 112 may match the arcuate shape formed by the blade housing 106 or may have a different curvature and/or shape. The recess 134 may similarly be formed with the arcuate shape so as to complimentarily receive the blade 108, first blade guard 110, and/or second blade guard 112 therein.

One or more openings 146 may be defined along the top edge of the blade 108, first blade guard 110, and/or second blade guard 112 such that when the first blade guard 110 and second blade guard 112 are arranged adjacent to the lateral sides of the blade 108, the openings align. The openings 146 may cooperate with the recess 134 in order to engage the blade 108, first blade guard 110, and/or second blade guard 112 with the recess 134. For example, where the blade 108, first blade guard 110, and/or second blade guard 112 are overmolded with the blade housing 106, the material forming the blade housing 106 may flow into and around the openings 146 so as to integrally form the curved blade assembly 104. In another example, the recess 134 may define one or more protrusions (not shown) that may act as the engagement mechanism to releasably engage the openings 146 defined along the top edge of the blade 108, first blade guard 110, and/or second blade guard 112. Actuation of the engagement mechanism may result in the protrusions engaging or disengaging the openings 146.

FIGS. 4B-4E further illustrate tabs 148a-d and grooves 150a-d arranged along an edge of the planar body portion 138, 142 of the first blade guard 110 and the second blade guard 112. Grooves 152a-d are correspondingly formed on the top edge of the blade 108. Each of the tabs 148a-d extend from and are coplanar with the planar body portion 138, 142 of the respective ones of the first blade guard 110 and the second blade guard 112 and are orientatable transversely to the planar body portion 138, 142 in a non-coplanar configuration. Each of the grooves 150a-d, 152a-d on the blade 108, first blade guard 110, and/or second blade guard 112 are arranged to receive a respective one of the tabs 148a-d in the non-coplanar configuration so as to securely sandwich the blade 108 therebetween in the non-coplanar configuration. In particular, a first tab 148a on the first blade guard 110 is folded over the first groove 152a on the blade 108 and the first groove 150a on the second blade guard 112 in the non-coplanar configuration, while a first tab 148b on the second blade guard 112 is folded over the second groove 152b on the blade 108 and the first groove 150b on the first blade guard 110. A second tab 148c on the first blade guard 110 is folded over the fourth groove 152d on the blade 108 and the second groove 150c on the second blade guard 112 in the non-coplanar configuration, while a second tab 148d on the second blade guard 112 is folded over the third groove 152c on the blade 108 and the second groove 150d on the first blade guard 110.

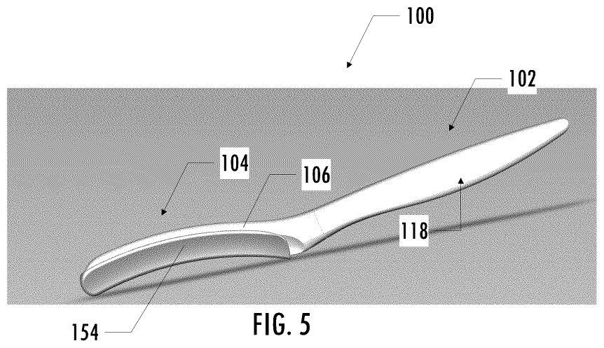

In some example embodiments, and as illustrated in FIG. 5, a cover 154 may be arrangeable about the curved blade assembly 104 so as to partially enclose the curved blade assembly 104. The cover 154 may be a translucent material, a transparent material, or any combination thereof. The cover 154 may extend over a substantial or partial entirety of the blade 108, first blade guard 110, and/or second blade guard 112, but not an entirety of the blade housing 106. Otherwise, the cover 154 may entirely cover the curved blade assembly 104, including the blade housing 106. In some example embodiments, the blade 108, first blade guard 110, and second blade guard 112 may not be removable from the blade housing 106 without the cover 154 enclosing at least the cutting edge 136 of the blade 108.

One or more peripheral components may be included with the curved blade dermaplaning device 100 including for example, one or more lighting arrangements, indicators, or the like. Where one or more electronic peripheral components are included (e.g., a lighting arrangement) supporting components (e.g., switch, sensor, battery, circuit board, charging port) may be provided to provide power to and/or control the electronic peripheral components. Where a lighting arrangement is used, the blade housing 106 may comprise a translucent material such that light from a light source of the lighting arrangement may pass through the translucent material so as to illuminate at least a portion of the curved blade assembly 104 and thereby a target area during use of the curved blade dermaplaning device 100. Alternatively, another portion of the curved blade assembly 104 may comprise a transparent material, or any other type of material that allows light to pass through the curved blade assembly 104. In some example embodiments, a motor (not shown) may be in used to cause one or more of heating, vibration, and reciprocation of the blade upon actuation of the motor. In some other example embodiments, a sensor mechanism (not shown) may be incorporated with the circuit. The sensor mechanism may be a type of mechanism that is able to determine if the user is using the device correctly, e.g., is applying enough pressure, user is holding the device at the desired angle, etc. The sensor mechanism may be a capacitive sensor, an accelerometer, pressure sensors, electrical conductivity sensors, optical sensors, force sensors, or combinations thereof. Feedback may be reported to the user via different colored lights, vibrations, and the like. For example, the sensor mechanism may be configured to detect whether the curved blade dermaplaning device 100 is being held, and as a result, output a signal to the lighting arrangement to automatically provide illumination.

In some example embodiments, not shown, a curved blade dermaplaning system may include the curved blade dermaplaning device 100 described herein and a blade dispenser (not shown). The blade dispenser may retain one or more replacement curved blade assemblies, including one or more of a blade 108, a first blade guard 110, a second blade guard 112, and/or a blade housing 106. To use, a user may remove the curved blade assembly 104 from the blade dispenser and engage it with or couple it to the first portion 114 of the handle 102.

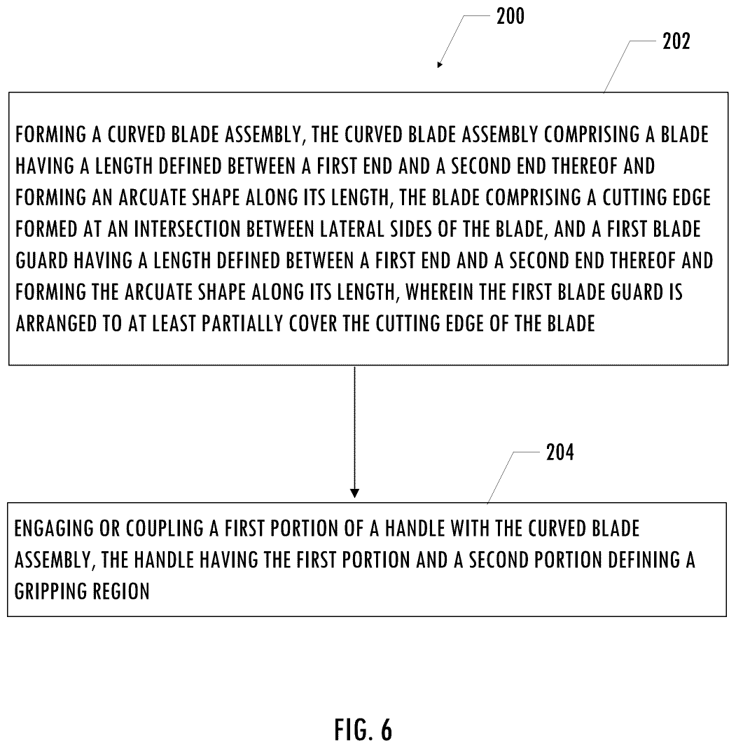

A method of manufacturing a curved blade dermaplaning device is illustrated in FIG. 6. The method, generally referred to as 200, may comprise a first step, 202, of forming a curved blade assembly, the curved blade assembly comprising a blade having a length defined between a first end and a second end thereof and forming an arcuate shape along its length, the blade comprising a cutting edge formed at an intersection between lateral sides of the blade, and a first blade guard having a length defined between a first end and a second end thereof and forming the arcuate shape along its length, wherein the first blade guard is arranged to at least partially cover the cutting edge of the blade. The method 200 may also comprise a second step 204, of engaging or coupling a first portion of a handle with the curved blade assembly, the handle having the first portion and a second portion defining a gripping region.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

1. A dermaplaning device comprising:
a handle having a first portion and a second portion defining a gripping region; and
a curved blade assembly engageable with or coupled to the first portion of the handle and comprising:
a blade having a length defined between a first end and a second end thereof and forming an arcuate shape along its length, the blade comprising a cutting edge formed at an intersection between lateral sides of the blade, and
a first blade guard having a length defined between a first end and a second end thereof and forming the arcuate shape along its length,
wherein the first blade guard is arranged to at least partially cover the cutting edge of the blade.

2. The device of claim 1, wherein the first blade guard comprises:
a planar body portion extending between the first end and the second end of the first blade guard and forming the arcuate shape along its length, and
guard teeth extending from and coplanar with the planar body portion in a planar configuration and orientable transversely to the planar body portion of the first blade guard in a non-coplanar configuration,
wherein the planar body portion of the first blade guard is arranged adjacent to one of the lateral sides of the blade and the guard teeth of the first blade guard are folded over the cutting edge of the blade in the non-coplanar configuration to partially cover the cutting edge of the blade.

3. The device of claim 2, wherein the curved blade assembly further comprises a second blade guard having a length defined between a first end and a second end thereof and forming the arcuate shape along its length, the second blade guard comprising:
a planar body portion extending between a first end and the second end of the second blade guard and forming the arcuate shape along its length, and
guard teeth extending from and coplanar with the planar body portion in a planar configuration and orientable transversely to the planar body portion of the second blade guard in a non-coplanar configuration,
wherein the planar body portion of the second blade guard is arranged adjacent to the other one of the lateral sides of the blade and the guard teeth of the second blade guard are folded over the cutting edge of the blade in the non-coplanar configuration to further partially cover the cutting edge of the blade.

4. The device of claim 3, wherein the guard teeth of the first blade guard and the guard teeth of the second blade guard oppose one another and are alternately folded over the cutting edge of the blade in the non-coplanar configurations thereof.

5. The device of claim 1, wherein the curved blade assembly comprises a blade housing having a portion forming the arcuate shape and to which the blade and the first blade guard are engaged with, the blade housing of the curved blade assembly being engageable with or coupled to the first portion of the handle.

6. The device of claim 5, wherein the first portion of the handle and the blade housing are integrally formed as a single unit, or the blade housing is attachable to and removable from the first portion of the handle.

7. The device of claim 5, wherein the blade housing defines a recess for engaging the blade and the first blade guard.

8. The device of claim 1, further comprising a cover arrangeable about the curved blade assembly so as to at least partially enclose the curved blade assembly.

9. The device of claim 1, wherein the curved blade assembly is longitudinally offset from the second portion of the handle.

10. The device of claim 8, wherein the arcuate shape defines a degree of curvature of between about 36 degrees and 37 degrees.

11. A method for manufacturing a curved blade dermaplaning device, the method comprising:
forming a curved blade assembly, the curved blade assembly comprising a blade having a length defined between a first end and a second end thereof and forming an arcuate shape along its length, the blade comprising a cutting edge formed at an intersection between lateral sides of the blade, and a first blade guard having a length defined between a first end and a second end thereof and forming the arcuate shape along its length, wherein the first blade guard is arranged to at least partially cover the cutting edge of the blade; and
engaging or coupling a first portion of a handle with the curved blade assembly, the handle having the first portion and a second portion defining a gripping region.

12. The method of claim 11, wherein the first blade guard comprises a planar body portion extending between the first end and the second end of the first blade guard and forming the arcuate shape along its length, and guard teeth extending from and coplanar with the planar body portion in a planar configuration and orientable transversely to the planar body portion of the first blade guard in a non-coplanar configuration, and
wherein forming the curved blade assembly comprises:
arranging the planar body portion of the first blade guard adjacent to one of the lateral sides of the blade; and
folding the guard teeth of the first blade guard over the cutting edge of the blade in the non-coplanar configuration to partially cover the cutting edge of the blade.

13. The method of claim 12, wherein the curved blade assembly further comprises a second blade guard having a length defined between a first end and a second end thereof and forming the arcuate shape along its length, the second blade guard comprising a planar body portion extending between a first end and the second end of the second blade guard and forming the arcuate shape along its length, and guard teeth extending from and coplanar with the planar body portion in a planar configuration and orientable transversely to the planar body portion of the second blade guard in a non-coplanar configuration, and
wherein forming the curved blade assembly comprises:
arranging the planar body portion of the second blade guard adjacent to the other one of the lateral sides of the blade; and
folding the guard teeth of the second blade guard over the cutting edge of the blade in the non-coplanar configuration to further partially cover the cutting edge of the blade.

14. The method of claim 13, wherein the guard teeth of the first blade guard and the guard teeth of the second blade guard oppose one another, and wherein forming the curved blade assembly comprises alternately folding the opposing guard teeth of the first blade guard and the guard teeth of the second blade guard over the cutting edge of the blade in the non-coplanar configurations thereof.

15. The method of claim 11, wherein the curved blade assembly further comprises a blade housing having a portion forming the arcuate shape; and
wherein forming the curved blade assembly comprises engaging the blade housing with the blade and the first blade guard, and
wherein engaging or coupling the first portion of the handle with the curved blade assembly comprises engaging or coupling the blade housing of the curved blade assembly to the first portion of the handle.

16. The method of claim 15, wherein engaging or coupling the first portion of the handle with the curved blade assembly comprises:
integrally forming the first portion of the handle and the blade housing as a single unit; or
attachably and removably engaging or coupling the blade housing with the first portion of the handle.

17. The method of claim 15, wherein forming the curved blade assembly comprises forming a recess in the blade housing for engaging the blade and the first blade guard.

18. The method of claim 11, further comprising arranging a cover about the curved blade assembly so as to at least partially enclose the curved blade assembly.

19. The method of claim 11, wherein engaging or coupling the first portion of the handle with the curved blade assembly comprises engaging or coupling the first portion of the handle with the curved blade assembly so that the curved blade assembly is longitudinally offset from the second portion of the handle.

20. The method of claim 11, wherein forming the curved blade assembly comprises forming the arcuate shape of the blade and the first blade guard, the arcuate shape defining a degree of curvature of between about 36 degrees and 37 degrees.
